(19) United States
(12) Patent Application Publication
(10) Pub. No.: US 2008/0283129 A1
(43) Pub. Date: Nov. 20, 2008

(54) Water Supply Shutoff Device

(76) Inventor: Luke Brown, Warwickshire (GB)

Correspondence Address: DOWNS RACHLIN MARTIN PLLC, 199 MAIN STREET, P O BOX 190, BURLINGTON, VT, 05402-0190, US

(21) Appl. No.: 11/568,726

(22) PCT Filed: May 5, 2005
(86) PCT No.: PCT/GB2005/001689

§ 371 Date: Jul. 29, 2008

(30) Foreign Application Priority Data
May 5, 2004 (GB) 0410024.4

(51) Int. Cl. F16K 37/00

(52) U.S. Cl. 137/486

(57) ABSTRACT

The present invention provides water supply shutoff device (10) for use with a water supply pipe (16). The device comprising a body (12) having water inlet (18) connectable to the upstream side of the water supply pipe, an water outlet (20) connectable to the downstream side of the water supply pipe, and a passage through said body connecting said water inlet to said water outlet (20). The body further includes a valve (26) operable close said passage and control means including an acoustic sensor (28) operable to detect the flow of water through the device, a timer and a drive means for the valve, the control means being arranged to operate the drive means to close the passage in response to water flowing through the device for a time period in excess of a predetermined time period. The device further includes a member (43) arranged in the passage to promote turbulence in the flow of water through the passage, which turbulence is detectable by the acoustic sensor (28).

The present invention relates to a water supply shutoff device.

Water damage to property can be caused by a water leak from a burst water supply pipe or a fault with an appliance which has a water supply. The water leak may continue for a considerable period before it is discovered by which time a significant amount of damage to property may already have been caused. Once discovered the water supply is typically manually shut off at a stopcock valve on the water supply pipe. Water leaks downstream of the stopcock valve are generally at the responsibility and cost of the end user. Water damage to property can be costly and time consuming to repair and the lengthy process of drying using dehumidifiers causes added disruption.

It is known to provide a device for shutting off a supply of water from a water supply pipe in the case of a drop in water pressure in the pipe above a pre-set threshold, such a drop in pressure being indicative of a water leak. The device has a water pressure switch which is adapted to activate a valve to isolate the water supply in the case of a significant drop in water pressure. The device is fitted by through cutting the supply pipe so that each free end of the pipe can be connected to the device. The device also requires a mains electricity supply to provide power for operation of the valve and the pressure switch.

Several problems are associated with the prior device for shutting off a supply of water. A qualified electrician may be required to connect the device to the mains electricity supply. The requirement for mains electricity cabling to the device and for a qualified fitter generally increases installation costs. The installation should preferably be close to the upstream side of the stopcock valve, where space is often restricted in a domestic installation.

A further problem is associated with the manner in which a water leak is detected by the prior device since a water leak might produce the same pressure drop as an appliance using water, such as a washing machine. If a water leak produces the same drop in pressure the device would not be triggered to shut off the water supply.

What is required is an improved water supply shut off device which is easier and less expensive to install and has an improved way of detecting a water leak condition.

According to a first embodiment of the present invention there is provided a water supply shutoff device for use with a water supply pipe, the device comprising a body having water inlet connectable to the upstream side of the water supply pipe, an water outlet connectable to the downstream side of the water supply pipe, and a passage through said body connecting said water inlet to said water outlet, the body including a valve operable to close said passage, wherein the device includes a control means including an acoustic sensor operable to detect the flow of water through the device, a timer and a drive means for the valve, the control means being arranged to operate the drive means to close the passage in response to water flowing through the device for a time period in excess of a predetermined time period, wherein the device further includes a member extending across the passage to promote turbulence in the flow of water through the passage, which turbulence is detectable by the acoustic sensor.

The presence of the turbulence inducing member enables the acoustic sensor to sense the flow of water through the device at relatively low flow rates.

The member may be substantially transverse to the direction of flow of water through the passage. Said member may preferably comprise a diaphragm having an aperture therethrough. The diaphragm may comprise a body of a flexible plastics or rubber-like material.

In a preferred embodiment the diaphragm is provided with a plurality of slots defining a plurality of flaps in the body thereof.

The control means includes a switch operable to place the device in one of a number of operative modes. In a preferred embodiment, one of said operative modes closes the valve, the valve remaining closed until the device is removed from said mode. Another of said operative modes may open the valve and disable the timer, the valve remaining open and the timer remaining disabled until the device is removed from said mode. In such a mode the control means may include an alarm, said alarm being arranged to sound periodically when the device is in the mode where the valve is open and the timer disabled. The switch may include a plurality of timer settings, each timer setting corresponding to a different predetermined time period for the timer.

In one embodiment one of the inlet and outlet of the device may be longer than the other of the inlet and outlet. The inlet and outlet may be substantially tubular and each are configured to receive an end of a water pipe therein. The longer of the inlet or outlet may be longer externally and/or internally.

The inlet and outlet are preferably each provided with a compression fitting arranged to receive an end of a water pipe in a leaktight manner. The inlet and outlet of the device may be aligned along a common axis.

In an alternative embodiment the body may include an openable jaw portion, said jaw portion being configured to receive a length of water pipe therein. The jaw portion may include a water pipe compression arrangement which, in use, compress the water pipe so as to prevent the flow of water therethrough. The acoustic sensor is preferably mounted to the body of the device in the vicinity of the passage, and a mounting member is provided between the sensor and body to insulate the sensor from external sound sources.

According to a farther embodiment of the invention there is provided a water supply shutoff device adapted for use with a water supply pipe, the device comprising a body and a jaw for receiving a water supply pipe therebetween, the device having a transverse water inlet, a transverse water outlet, a passage connecting said inlet and outlet, and a valve in said passage, the inlet and the outlet having means adapted to pierce a water supply pipe in use to permit water flow from the inlet to the outlet via said passage, the device adapted to be powered by an internal power source and further including a control circuit having a timer and an acoustic sensor, the sensor adapted to sense water flow in the passage and the control circuit adapted to operate the valve to shut off the flow in response to flow for a period of time greater than a pre-set time period.

A device so arranged can be fitted to a water supply pipe such as a copper or plastic pipe and may be used to reduce the amount of water damage to property in the event of a water leak. The device is straight forward to fit and requires only one through cut of a water supply pipe, each free end of the pipe being closed by a cap. The device is preferably battery powered which eliminates the requirement for a mains electricity supply thereby reducing installation costs. The device may be provided with an internal power generation means in order to replenish the battery. Such means may comprise a generator driven by the movement of water in the device. In use the device provides a way of isolating a water leak which has occurred for longer than a predetermined period of time. Piercing of the pipe provides a convenient way of making a connection to divert the flow of water through the device.

In an alternative embodiment the device is provided with a crimping means adapted to stop water flow in a water supply pipe in use.

Using such a crimping means eliminates the requirement for a through cut of the water supply pipe and capping of the free ends thereof, which reduces the requirement for a skilled plumber to install the device. In this manner the device is less complex to fit. The crimping means is particularly effective with a malleable pipe should as a copper pipe. In use, the crimping means prevents any substantial flow of water in the pipe under normal mains water pressure.

In a further embodiment closing of the jaw relative to the body causes the pipe to be crimped by the crimping means.

Preferably the crimping means comprises a crimping member associated with each of the jaw and the body. Preferably each crimping member is elongate. In a preferred embodiment the crimping members are arranged transverse to a water supply pipe, in use.

Preferably each crimping member has a curved surface to contact a water supply pipe, in use. Such a curved surface inhibits splitting of the pipe during crimping. In a preferred embodiment the crimping members have an arcuate cross section. A suitable radius for use with a standard 15 mm diameter water supply pipe is in the range 7 mm 11 mm. Preferably the radius is substantially 9 mm. Preferably the radius of each crimping member is in the range of one half to two thirds the radius of the water supply pipe.

Preferably the crimping members are offset from one another relative to the direction of the pipe axis in use. A suitable offset for use with a standard 15 mm diameter water supply pipe is in the range 4-6 mm. Preferably the offset is substantially 5 mm. Preferably the offset is in the range one-third to two-thirds the diameter of a circular crimping member.

Each of the body and the jaw may be provided with a step. Such a step is a useful feature to accommodate a degree of offset in the water supply pipe which may be provided as a result of crimping of the water supply pipe.

Preferably the water inlet and the water outlet are provided in the body.

Preferably the body has an inlet mounting and an outlet mounting, the inlet mounting associated with the water inlet and the outlet mounting associated with the water outlet.

In a preferred embodiment the means adapted to pierce comprise a respective water. inlet screw and a water outlet screw, the inlet screw and the outlet screw being adapted to be screwed into the device to pierce a water pipe in use.

Each of the water inlet screw and the water outlet screw are provided with a respective head to permit screwing of the inlet screw into the device.

Each head of the respective water inlet screw and the water outlet screw are provided with an respective head washer to provide a seal with the respective inlet mounting and outlet mounting. Each of the water inlet screw and the water outlet screw may be provided with a respective inlet washer and an outlet washer to seal a water supply pipe to the device, in use.

In a preferred embodiment the jaw is pivotably connected to the body. Such a device is easy to fit around a household water supply pipe adjacent a wall which may have restricted access. Preferably a closing means is provided at the free ends of the jaw and the body. Such an arrangement provides a mechanical advantage when closing the device to crimp the pipe.

In one embodiment the closing means comprises a pivotable mounting at the free end of one of the jaw and the body, the pivotable mounting having a screw-threaded fastener which is locatable in a through hole in the other of the jaw and the body.

In another embodiment the closing means comprises a pivotable mounting at the free end of one of the jaw and the body, the pivotable mounting having a screw-threaded fastener which is adapted to contact the other of the jaw and the body.

In a preferred embodiment the control circuit operates to measure water flow after a predetermined period of time in use. Such operation prolongs battery life of the device. Typically a reading of flow is taken every few seconds.

Preferably the valve is a solenoid valve. The solenoid valve is pulse operated in use, to prolong the lifetime of the battery.

Preferably the sensor is an acoustic sensor. Such a sensor detects vibrations, turbulence and/or noise caused by the water flowing in the pipe, in use.

Preferably the control circuit is adapted to provide an alert signal when the battery has discharged to a predetermined level, in use. Operating the device in this manner provides a warning to the user that the battery requires replacement. Preferably the alert signal is an audible alert signal.

The control circuit may be provided with an override switch to prevent the solenoid valve from operating to shut off the water supply. This is a useful feature if a water demand is required for a prolonged period of time which would ordinarily exceed the pre-set time for shutting off the water supply.

The control circuit may be provided with means to adjust the pre-set time period. Such a feature is useful to permit the pre-set time period to be changed and set for a particular premises.

According to another embodiment of the invention there is provided a water supply shutoff device adapted for use with a water supply pipe, the device comprising a body, the device having a longitudinal water inlet, a longitudinal water outlet, a passage connecting said inlet and outlet, and a valve in said passage, the inlet and the outlet having means adapted to connect to a water supply pipe in use to permit water flow from the inlet to the outlet via said passage, the device adapted to be battery powered and further including a control circuit having a timer and an acoustic sensor, the sensor adapted to sense water flow in the passage and the control circuit adapted to operate the valve to shut off the flow in response to flow for a period of time greater than a pre-set time period.

Optional features of the second and third embodiments of the invention may be used with the first embodiment of the invention, and vice versa.

Other features of the invention will be apparent from the following description of a preferred embodiment shown by way of example only in the accompanying drawings, in which:

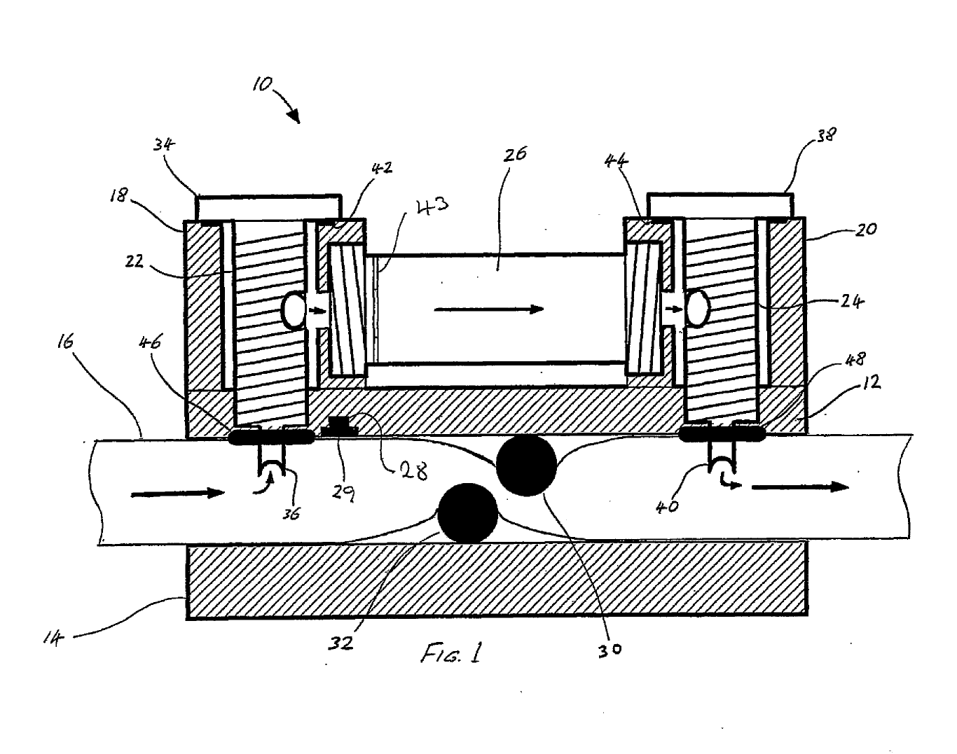

FIG. 1 is a schematic cross section showing the internal structure of a water supply shutoff device according to a first embodiment of the present invention;

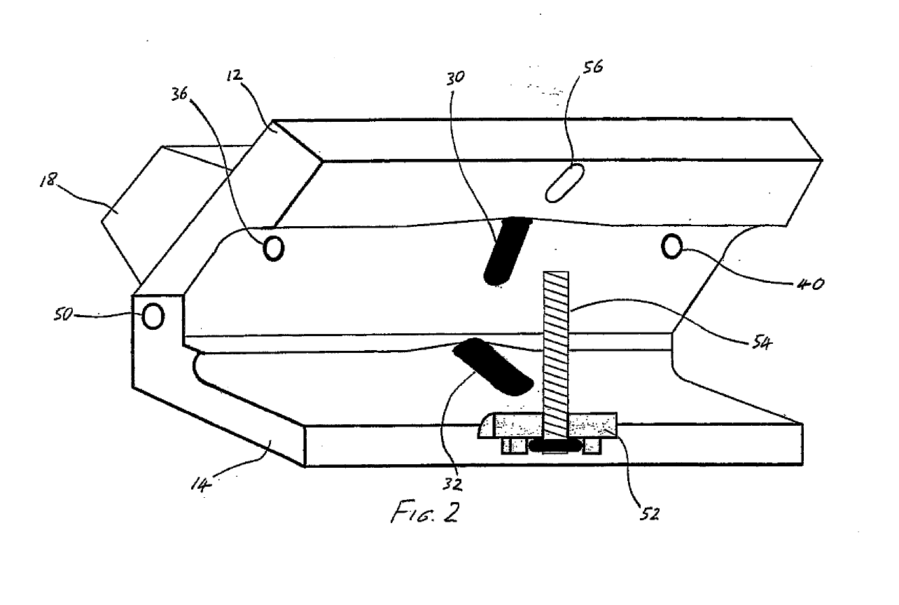

FIG. 2 is a diagrammatic perspective representation of the device of FIG. 1 shown in the open condition;

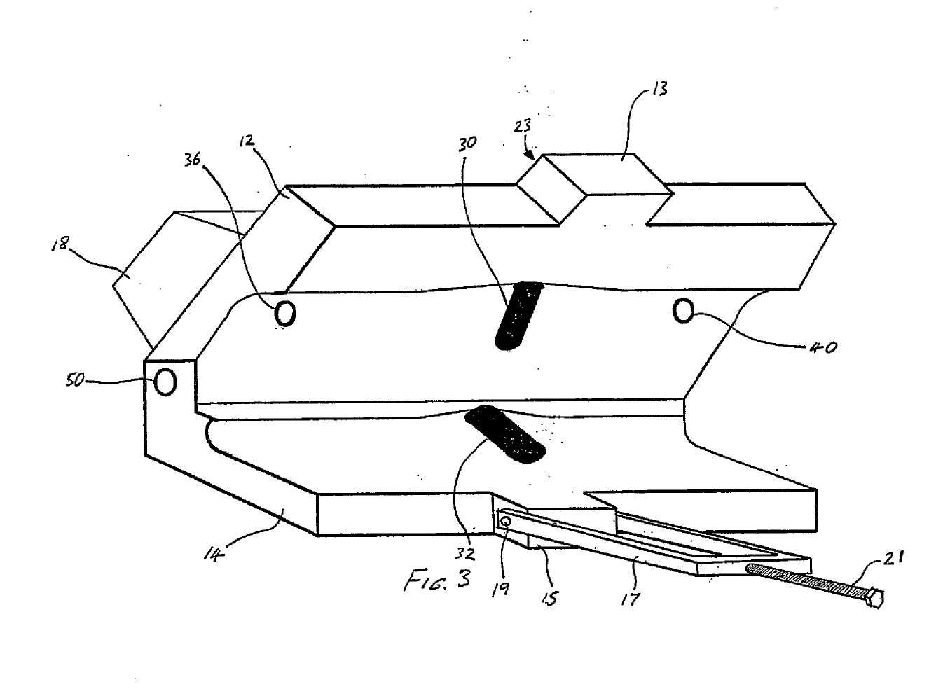

FIG. 3 is a diagrammatic perspective representation of the device of FIG. 2 according to an alternative configuration;

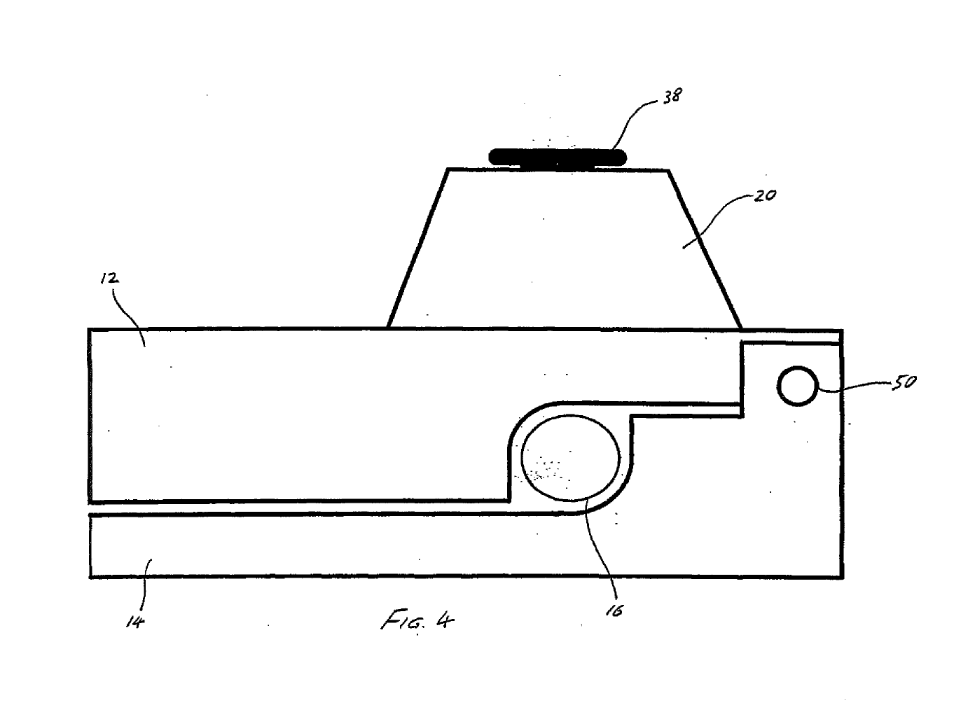

FIG. 4 is a diagrammatic end view of the device of FIG. 1 shown in the closed condition;

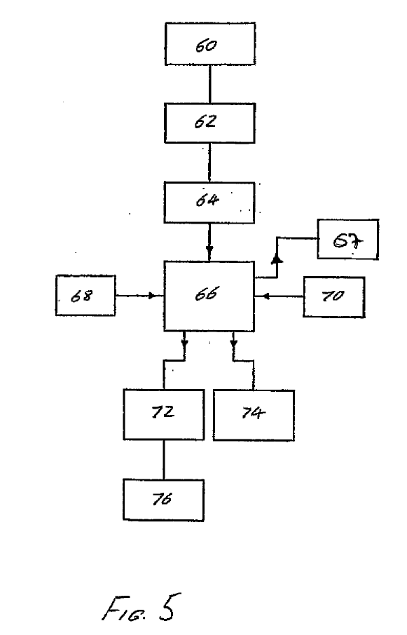

FIG. 5 is a schematic diagram showing the operation of the electronic control circuitry;

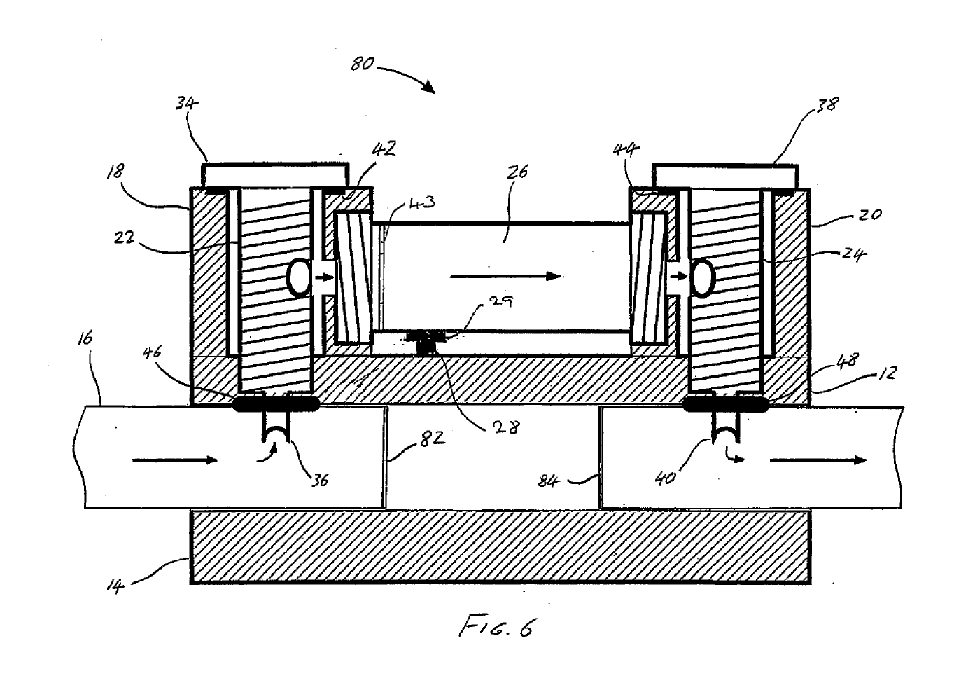

FIG. 6 is an alternative configuration of the shutoff device of FIG. 1.

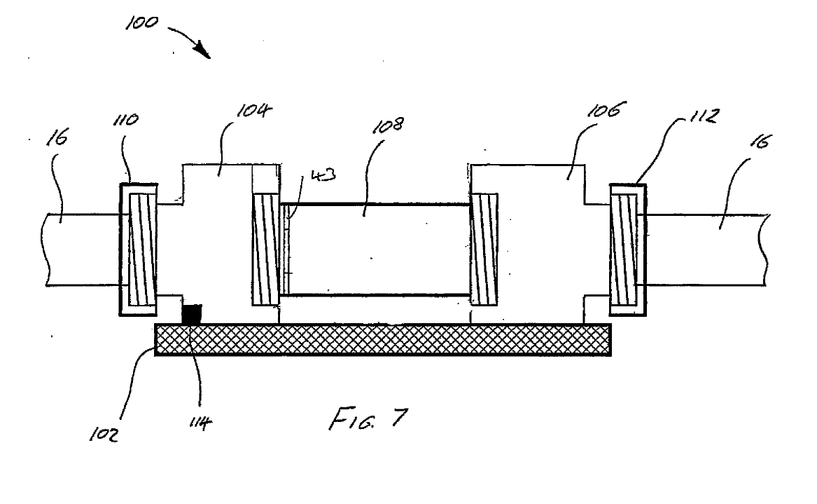

FIG. 7 is a side view of a water supply shutoff device according to a second embodiment of the present invention;

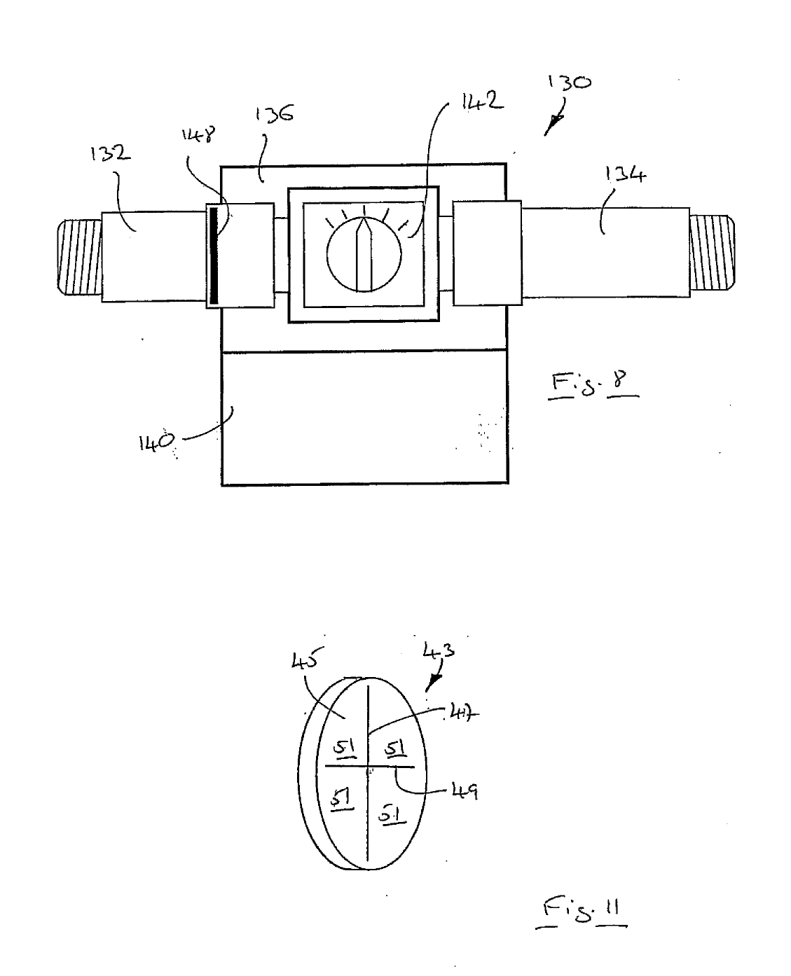

FIG. 8 is a side view of an alternative configuration for a device according to the second embodiment of the present invention;

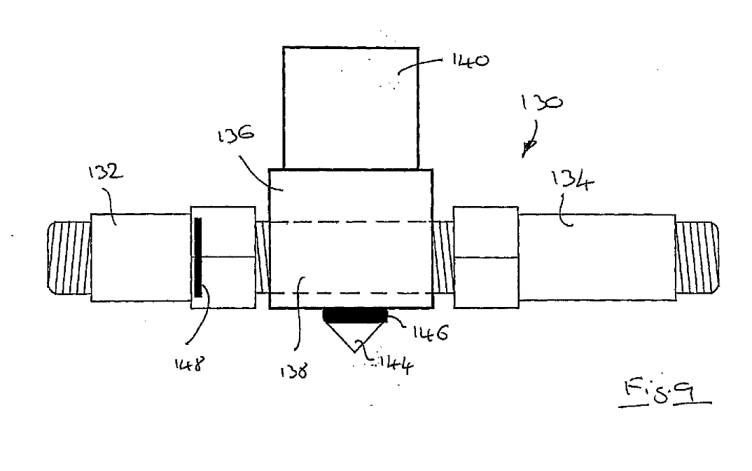

FIG. 9 is a plan view of the device of FIG. 8;

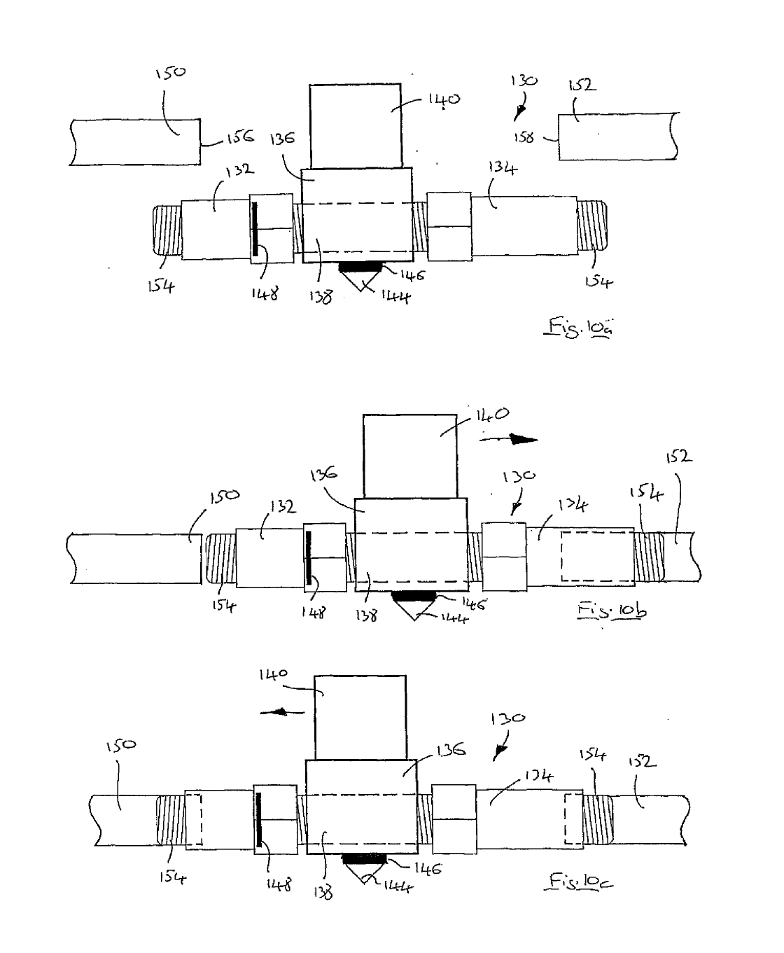

FIG. 10a to 10c show plan views of the fitting of the device of FIG. 8 to opposed lengths of water pipe; and

FIG. 11 shows a perspective view of an elastomeric insert of the device.

Referring firstly to FIG. 1 there is shown a schematic cross section showing the internal structure of a water supply shutoff device according to a first embodiment of the present invention, generally designated 10. The device 10 comprises a body 12 having a jaw 14. The body 12 and the jaw 14 are adapted to locate around a water supply pipe 16 such as a copper pipe having a diameter of substantially 15 nun. The body 12 has an inlet mounting 18 and an outlet mounting 20, the inlet mounting 18 and the outlet mounting 20 being secured to the body 12. The inlet mounting 18 has an inlet screw 22, the outlet mounting 20 has an outlet screw 24. A solenoid valve 26 is positioned between the inlet mounting 18 and the outlet mounting 20. The body 12 has an acoustic sensor, such as a microphone 28, for sensing the flow of water and to provide a signal to a control circuit (not shown) for operating the solenoid valve 26. The microphone 28 is provided in a mounting 29. The mounting 29 provides a sound conduction path between the body 12 and the microphone 28 and further prevents the microphone from picking up sounds or vibrations not emanating from the device 10. The mounting 29 may comprise a foamed plastics or rubber-like material.

FIG. 1 also shows each of the body 12 and the jaw 14 having a respective crimping member 30, 32. The crimping members 30, 32 have a circular cross section with a diameter of substantially 9 mm. The crimping members 30, 32 are offset from one another by substantially 5 mm and are adapted to crimp the pipe 16 to stop water flow when the jaw 14 is closed relative to the body 12. Also shown in FIG. 1 the inlet screw 22 is provided with a head 34 and a cutting inlet 36. The head 34 permits screwing of the inlet screw 22 into the body 12 so that the cutting inlet 36 cuts into the pipe 16. Similarly the outlet screw 24 is provided with a head 38 and a cutting outlet 40 so that screwing the outlet screw 24 into the body 12 causes the cutting outlet 40 to cut into the pipe 16. The inlet screw 22 and the outlet screw 24 are each provided with an respective head washer 42, 44 to provide a seal with the respective inlet mounting is and outlet mounting 20. Each of the inlet screw 22 and the outlet screw 24 are also provided with a respective inlet washer 46, 48 to seal the pipe 16 to the body 12.

The device 10 is further provided with an optional insert 43 which extends fully across the flowpath through the device 10 on the inlet side of the solenoid valve 26 to assist the microphone 28 in sensing the flow of water through the device 10. During periods of high water flow rate through the device 10 it has been observed that the microphone 28 does not experience any difficulty in determining that water is flowing through the device. A period of high flow rate may be due, for example, to a burst pipe downstream of the device 10 or a tap left fully open. During periods of lower, but continuous, flowrate the microphone 28 may have difficulty in determining that water is flowing through the device 10 and hence may not supply a signal to the control circuit. Low flowrate detection by the microphone 28 is assisted by the use of the insert 43 which is shown in greater detail in FIG. 11. The insert 43 comprises a flexible diaphragm 45 having one or more slots therein, which slots extent filly through the body of the diaphragm 45. The diaphragm is made from a flexible material such as, for example, flexible plastic or rubber-like material which is resistant to tearing. In the embodiment shown the diaphragm 45 is provided with two slots 47,49 which are arranged in the form of a cross. The slots 47,49 thus define four flaps 51 in the body of the diaphragm 45.

The resilient nature of the diaphragm body 45, coupled the presence of the slots 47,49 and flaps 51, causes the insert 43 to operate in the following manner. During periods of zero flowrate through the device 10, the insert 43 adopts the configuration shown in FIG. 11. Once water starts to flow through the device 10 the flaps 51 are deflected outwardly in the direction of the flow thereby opening a flow aperture in the diaphragm 45. At the maximum flow rate the flaps open fully 51 and therefore do not significantly inhibit the flow of water through the device 10 and hence the pressure drop across the insert 43 is minimal. At flow rates lower than maximum the flaps 51 open partially and allow water to flow through the device 10. In passing through the partially open flaps 51 turbulence is induced in the flow which in turn creates noise which is detected by the microphone 28. The insert 43 is optional in the embodiment of the invention described with reference to FIGS. 1 to 6 as the convoluted path which the water is required to take through the device 10,80 promotes turbulence, and hence noise, at low flow rates.

It will be appreciated that the configuration of the insert 43 may differ from that shown in FIG. 11. For example, the insert 43 may be provided with a greater or lesser number of slots and flaps. The insert 43 may take other forms which function in a similar manner to that described, i.e. inducing turbulence at lower flowrates while not impeding flow at higher flowrates.

Now turning to FIG. 2 there is shown a diagrammatic perspective representation of the device 10 of FIG. 1 shown in the open condition. Like features are shown with like reference numerals. In FIG. 2 a pivot pin 50 is shown to permit the body 12 to pivot relative to the jaw 14. A pivotable mounting 52 is also shown at the free end of the jaw 14. The pivotable mounting 52 has a bolt 54 which is locatable in an elongate through hole 56 of the body 12.

In FIG. 3 there is shown a diagrammatic perspective representation of the device of FIG. 2 according to an alternative embodiment. Like features to the embodiment shown in FIG. 2 are shown with like reference numerals. In FIG. 3 each of the body 12 and the jaw 14 are provided with a respective protrusion 13, 15 at the respective free end thereof. The protrusion 15 on the jaw has a fork 17 pivotable mounted thereon at 19. The fork 17 has a threaded fastener 21. In use the fork 17 is used to close the body 12 relative to the jaw 14 by pivoting the fork 17 over the protrusion 13 of the body 12 and screwing the fastener 21 into the fork 17 so that the free end of the fastener abuts with a top surface 23 of the protrusion 13 of the body 12.

In FIG. 4 there is shown a diagrammatic end view of the device 10 of FIG. 1 shown in the closed condition. The body 12 and the jaw 14 are clamped together using a nut (not shown) threaded onto the bolt 52. Such a clamping arrangement provides a mechanical advantage when closing the device 10 to crimp the pipe 16.

FIG. 5 shows a schematic diagram showing the operation of the electronic control circuitry. An input signal 60 from the microphone 28 is fed to a microphone amplifier 62 which is then fed through an input filter 64 to produce a filtered signal. The filtered signal is then input to a micro controller 66 for processing. Power to operate the micro controller 66 and the solenoid valve 26 is provided from a battery 68. The micro controller 66 is also provided with a timer 70 for time measurement purposes. The micro controller 66 provides an output to a voltage step-up circuit 72 and an indicator alarm 74. The step-up circuit provides a signal 76 to operate the solenoid 26. In use the control circuitry operates to measure water flow on an intermittent basis to prolong battery life. The solenoid valve is pulse operated which also prolongs the lifetime of the battery. Typically a reading is taken from the microphone 28 every few seconds.

In use the device 10 can be used to shut off a water supply to a household in response to an alert condition detected by the device 10. The device 10 is clamped around a water supply pipe 16 just downstream of a stopcock of a water supply pipe so that the pipe 16 is between the body 12 and the jaw 14. The clamping operation causes the pipe 16 to be crimped by the crimping members 30, 32 such that the water supply is prevented from flowing in the pipe 16 under normal mains water pressure. The crimping operation may introduce an offset in the water supply pipe 16. The body 12 and the jaw 14 may be provided with a step to accommodate such an offset. Each of the inlet screw 22 and the outlet screw 24 are then screwed into the body 12 so that the cutting inlet 36 and the cutting outlet 40 cut respective holes in the pipe 16. The water can then pass into the cutting inlet 36, through the inlet screw 22, through the solenoid valve 26, through the outlet screw 24, through the cutting outlet 40 and back into the pipe 16 to supply water to the household. If water flow is detected by the microphone 28 for longer than a predetermined period of time the control circuit operates the solenoid valve to shut off the flow of water through the device 10.

When the battery discharges to a predetermined level the device is adapted to provide an audible alert signal to alert a user that the battery requires replacement. The control circuitry is provided with an override switch to prevent the solenoid valve 26 from operating to shut off the water supply. This is a useful feature if a hose pipe is to be used for a prolonged period of time which would ordinarily exceed the predetermined time for shutting off the water supply.

The device 10 does not require a through cut of the pipe 16. In this manner the device 10 is less complex to fit than the prior water shut off device. The device 10 is battery operated and is not required to be connected to a mains electricity supply. Due to the simplicity of fitment of the device 10 a plumber or an electrician are not required which reduces the overall cost of installing the device 10. The device is a simple and low cost item that can be fitted to a water supply pipe by a person of normal skill.

Referring now to FIG. 6 there is shown an alternative embodiment of the shutoff device of FIG. 1, generally designated 80. Like features to the embodiment of FIG. 1 are shown with like reference numerals. In FIG. 6 the device 80 is intended for use where a water supply pipe 16 has been cut through and where each free end of the pipe 16 has been closed with cappings 82, 84. The water supply device 80 of FIG. 6 does not require crimping members 30, 32 as shown in FIG. 1. Once the device 80 has been clamped around a water supply pipe 16 the inlet screw 22 and the outlet screw 24 are screwed into the body 12 in the same manner as the device 10 of FIG. 1. The embodiment of the device 80 shown in FIG. 6 shows the microphone 28 and its associated mounting 29 is provided on the body of the solenoid valve 26. In use operation of the device 80 of FIG. 6 is the same as the device 10 of FIG. 1.

Now referring to FIG. 7 there is shown a side view of a water supply shutoff device according to a second aspect of the invention, generally designated 100. The device 100 has a body 102 with a longitudinal inlet 104 and a longitudinal outlet 106 mounted thereon. A solenoid valve 108 connects the inlet 104 and the outlet 106. In use the device 100 is fitted between free ends of a pipe 16 by compression fit connectors 110, 112. The solenoid valve 108 is provided with a microphone 114 and an insert 43 to detect water flow in the device 100. In use the operation of the device 100 of FIG. 7 is the same as the device 10 of FIG. 1, and employs a control circuit having the same features as those shown in FIG. 5.

Referring now to FIGS. 8 to 10c there is shown an alternative embodiment of a device 130 according to the present invention. The device 130 is similar to that described with reference to FIG. 7 and operates in the same manner as the previously described embodiments. The device 130 comprises an inlet 132, an outlet 134 and a body 136 connected to and disposed between and the inlet and outlet 132,134. The body 136 includes a conduit or flowpath 138 extending therethrough between the inlet and outlet 132,134. The body 136 includes a solenoid valve which is operable to close the conduit 138 and thereby isolate the inlet 132 from the outlet 134. Mounted to the body 136 is a microphone 144 which is arranged to detect the acoustic signature of water passing through the conduit 138. The microphone 144 is provided on a mounting 146 in intimate contact with the body 136. The mounting 146 provides a sound conduction path between the body 136 and the microphone 144 and further prevents the microphone from picking up sounds or vibrations not emanating from the device 130, The mounting 146 may comprise a foamed plastics or rubber-like material. The inlet 132 of the device 130 is provided with an insert 148 of the type described above to assist the microphone 144 in detecting low water flow rates through the device 130.

The microphone 144 is mounted to what is, in use, the underside of the device 130 so as to prevent it from being susceptible to damage.

While the insert 148 is described as being optional for earlier described embodiments of the invention, the straight through nature of the device 130 of FIG. 7 necessitates the use of an insert to promote turbulence and/or noise at low flow rates. The device 130 of FIG. 7 shows the insert 148 positioned within the inlet 132. It will be understood that the insert may alternatively be provided in the outlet 134.

Mounted on the body 136 there is provided a casing 140 which houses a control circuit of the type described above as well as a battery pack to provide power for the solenoid and control circuit. The casing 140 is also provided with a multi-position switch 142 which can be used to control the operation of the device 130. The switch 142 has a first setting, referred to as an “off” setting, which causes the solenoid valve to close the conduit 138 and keep the conduit 138 closed until the switch 142 is moved to another position. The “off” setting may be used in instances where a property is to be left vacant for a period of time.

The switch 142 is also provided with a “freeflow” setting whereupon the solenoid valve is open and the control circuit is disabled. With the device 130 in the “freeflow” setting it will be understood that the solenoid valve will not operate after a predetermined period of time of water flow through the device 130. The “freeflow” setting may be used by a householder or the like when they wish to use a large volume of water, the supply of which may otherwise cause the device 130 to activate. For example, a householder may wish to use a hose pipe for an extended period of time to wash a vehicle or water a garden. With the device 130 in the “freeflow” setting, the control circuit may advantageously sound the alarm periodically to indicate that the device 130 is in the “freeflow” setting. The periodic sounding of the alarm serves to remind the householder to remove the device 130 from the “freeflow” setting once their extended period of water usage is over.

Between the “off” and “freeflow” settings of the switch 142 there is provided at least one “operational” setting. With the switch 142 in the “operational” setting the device 130 operates in the manner described above, i.e. causing the solenoid valve to close the conduit 138 after the control circuit has sensed water passing through the conduit 138 for a time in excess of predetermined time period. The switch 142 may be provided with a plurality of “operational” settings. Each different “operational” setting may correspond to the control circuit causing the solenoid valve to operate after differing time period. It will thus be understood that the operation of the device 130 may be tailored to the expected water usage profile of a building to which it is associated. It will be understood that a small dwelling, such as a flat, having a single occupant may be expected to use less water that a larger dwelling, such as a multi-bedroomed detached house with more than one bathroom, having multiple occupants. Accordingly the activation time period for the device 130 fitted to the flat may be less than that for the house. Prior to the installation of the device 130 a water usage survey for the property to which it is to be installed can be undertaken and the appropriate activation time period determined. The device 130 may be provided with the option of programming a specific time period into the control circuit.

It will be noted that the inlet 132 is shorter than the outlet 134. This feature assists in the installation of the device 130 as will now be described with reference to FIGS. 10a to 10c. The inlet and outlet 132,134 are tubular and are each sized to receive a length of water pipe 150,152. The inlet and outlet 132,134 are each provided with a compression fitting 154 within which the appropriate length of water pipe 150,152 may be inserted the compression fittings 154 are conventional and of the type which permit lengths of water pipe to be connected to one another without the need for soldering or brazing operations or the need to provide threaded connectors.

To install the device 130 a section of pipe is removed from a water pipe so as to provide two opposed lengths of water pipe 150,152 which are aligned along a substantially common axis. It will be noted that the distance between the ends 156,158 of the pipe lengths 150,152 is less than the length of the device 130 (FIG. 10a). To fit the device 130 the downstream pipe length 152 is inserted into the device outlet 134. The extra length of the outlet 134 allows the inlet 132 to be aligned with the upstream pipe length 150 (FIG. 10b). The upstream pipe length 150 can subsequently be inserted into the inlet 132 as indicated in FIG. 10c and the device 130 centralised. It will be appreciated that the device 130 may be constructed such that the relative lengths of the inlet and outlet 132,134 are reversed. It will further be appreciated that the device 130 may be configured such that the external dimensions of the inlet and outlet 132,134 are equal, while one is internally configured to receive a length of pipe to a greater depth than the other.

The control circuit of the devices hereinbefore described may be configured to send information relating to the operation of the device to a location remote from the device. For example, the control circuit may be connected to a wireless transmission means 67 (see FIG. 5) which may be arranged to send a message in SMS format to one or more predetermined mobile telephone numbers. The control circuit may be arranged to transmit information to a control panel within the building which the device is associated with.

1. A water supply shutoff device for use with a water supply pipe, the device comprising a body having water inlet connectable to the upstream side of the water supply pipe, an water outlet connectable to the downstream side of the water supply pipe, and a passage through said body connecting said water inlet to said water outlet, the body including a valve operable to close said passage, wherein the device includes a control means including an acoustic sensor operable to detect the flow of water through the device, a timer and a drive means for the valve, the control means being arranged to operate the drive means to close the passage in response to water flowing through the device for a time period in excess of a predetermined time period, wherein the device further includes a member extending across the passage to promote turbulence in the flow of water through the passage, which turbulence is detectable by the acoustic sensor.

2. A device as claimed in claim 1 wherein the member is substantially transverse to the direction of flow of water through the passage.

3. A device as claimed in claim 1 wherein said member comprises a diaphragm having an aperture therethrough.

4. A device as claimed in claim 3 wherein said diaphragm comprises a flexible plastics material.

5. A device as claimed in claim 4 wherein the diaphragm is provided with a plurality of slots defining a plurality of flaps in the body thereof.

6. A device as claimed in claim 1 wherein the control means includes a switch operable to place the device in one of a number of operative modes.

7. A device as claimed in claim 6 wherein one of said operative modes closes the valve, the valve remaining closed until the device is removed from said mode.

8. A device as claimed in claim 6 wherein one of said operative modes opens the valve and disables the timer, the valve remaining open and the timer remaining disabled until the device is removed from said mode.

9. A device as claimed in claim 8 wherein the control means includes an alarm, said alarm being arranged to sound periodically when the device is in the mode where the valve is open and the timer disabled.

10. A device as claimed in claim 6 wherein the switch includes a plurality of timer settings, each timer setting corresponding to a different predetermined time period for the timer.

11. A device as claimed in claim 1 wherein one of the inlet and outlet of the device is longer than the other of the inlet and outlet.

12. A device as claimed in claim 11 wherein the inlet and outlet are substantially tubular and each are configured to receive an end of a water pipe therein.

13. A device as claimed in claim 12 wherein the inlet and outlet are each provided with a compression fitting arranged to receive an end of a water pipe in a leaktight manner.

14. A device as claimed in claim 11 wherein the inlet and outlet of the device are aligned along a common axis.

15. A device as claimed in claim 1 wherein the body includes an openable jaw portion, said jaw portion being configured to receive a length of water pipe therein.

16. A device as claimed in claim 15 wherein said jaw portion includes a water pipe compression arrangement which, in use, compress the water pipe so as to prevent the flow of water therethrough.

17. A device as claimed in claim 1 wherein the control means includes a wireless transmission means operable to transmit information relating to the operation of the device.

18. A device as claimed in claim 1 wherein the acoustic sensor is mounted to the body of the device in the vicinity of the passage, and a mounting member is provided between the sensor and body to insulate the sensor from external sound sources.
